(19) United States
(12) Patent Application Publication
(10) Pub. No.: US 2026/0194192 A1
(43) Pub. Date: Jul. 9, 2026

(54) Oxygen Tank Holder

(71) Applicant: Ikhtiyorjon Abdupattoev, Philadelphia, PA (US)

(72) Inventor: Ikhtiyorjon Abdupattoev, Philadelphia, PA (US)

(21) Appl. No.: 19/012,746

(22) Filed: Jan. 7, 2025

(51) Int. Cl. F17C 13/08

(52) U.S. Cl. CPC F17C 13/084; F17C 2205/0107; F17C 2205/013; F17C 2221/011

(57) ABSTRACT

The invention pertains to a holder designed for holding cylinders. The attachable holder system includes two plates—a top plate and a bottom plate—connected by at least four pipes, along with at least one fastening mechanism. The top plate forms at least four compartments, at least four apertures, and at least four side bracket plates; while bottom plate features at least four compartments, at least four apertures, at least four side bracket plates, and at least four supporting baseplates on its underside. The pipes securely connect the top and bottom plates, forming or assembling a sturdy structure to hold the oxygen tanks or cylinders. A fastening mechanism, which includes fasteners, is employed to secure the holder system in place. This system facilitates the transportation and portable oxygen tanks or cylinders in vehicles, at various locations, and during manual handling.

### FIELD OF THE INVENTION

The present invention relates to holding the oxygen tanks or cylinders.

### BACKGROUND

Cylinders or tanks containing pressurized gases like air or oxygen are widely used in fields such as fire and rescue, often paired with breathing apparatuses. These cylinders are typically handled in challenging environments, where improper storage and transportation pose significant safety risks due to the high pressures involved. The harsh conditions and standard handling practices subject the cylinders to considerable wear and tear, reducing their lifespan and reliability. Generally, cylinders are carried by the valve assembly, with no built-in mechanism to ensure stability when placed on a surface or the ground. In emergency situations, a cylinder can easily roll when placed on the ground, creating a hazard. This can lead to cylinder damage, such as a broken valve, or even injuries to people and damage to surrounding objects if the cylinder or valve ruptures.

The prior art addresses portable holder for use in transporting cylinders such as gas cylinders that are used by fire and rescue services. For example, U.S. Pat. No. US20040159621A1, by Richard DenikeAb Neufeldt., issued 2006 Jul. 4 entitled “Portable cylinder holder, carrier and securing system”, details a method for securing and storing two cylinders. This prior art document focuses solely on a method for storing two cylinders and highlights the issue of excessive space consumption when both compartments of the holder are empty or not in use.

The prior art, while considering the storage of two cylinders and the attachable or detachable aspects of the holder system, fails to sufficiently address the issues of space consumption and the handling of more than two cylinders

### BRIEF DESCRIPTION OF DRAWINGS

The present invention will be described in conjunction with the drawings in which:

FIG. 1 is a perspective view of the top plate;

FIG. 2 is a perspective view of the bottom plate;

FIG. 3 is a front view of the pipe;

FIG. 4 is a top perspective view of the oxygen tank holder system;

FIG. 5 is a top perspective view of the oxygen tank holder system;

FIG. 6 is a top view of the oxygen tank holder system;

FIG. 7 is a bottom view of the oxygen cylinder tank system;

FIG. 8 is a top view of another embodiment of the oxygen tank holder system;

FIG. 9 is a bottom view of another embodiment of the oxygen tank holder system;

FIG. 10 is a top perspective view of another embodiment of the oxygen tank holder system;

FIG. 11 is a bottom perspective view of another embodiment of the oxygen tank holder system;

FIG. 12 is a top view of another embodiment of the top plate;

FIG. 13 is a top view of another embodiment of the bottom plate;

FIG. 14 is a top perspective view of another embodiment of the oxygen tank holder system.

### SUMMARY

The present invention provides a means of holding oxygen cylinders. The invention stabilizes, protects and secures the cylinders during all phases of holding.

The system incorporates at least four cylinders holder that secures the cylinders inside the holder. The holder can be placed for use either at a location like hospital or in a compartment of a vehicle, such as an ambulance but not limited said location.

In accordance with one aspect of the present invention, there is provided an attachable or detachable and portable holder for use in holding up to four cylinders, comprising: a top plate, a bottom plate, at least four pipes, and at least a fastening mechanism. The top plate includes at least four compartments, at least four side bracket plates for joining said compartments and at least four apertures located on the said top plate; the bottom plate features at least four compartments, at least four side bracket plates for joining said compartments, at least four apertures located on the said bottom plate, and at least four supporting baseplates on its underside for protecting cylinders from the bottom side; said pipes are used to connect the top and bottom plates through said apertures; and said fastening mechanism is used to join one end of each pipe to said apertures located on said top plate and the other end to said apertures located on said bottom plate.

In accordance with another aspect of the present invention, there is provided an attachable and portable holder for use in holding up to four cylinders, comprising: a top plate, a bottom plate, at least four pipes, and at least a fastening mechanism. The top plate includes at least four compartments, at least four side handles or handle-like plates for joining said compartments and at least four apertures located on the said top plate; the bottom plate features at least four compartments, at least four side handles or handle-like plates for joining said compartments, at least four apertures located on the said bottom plate, and at least four supporting baseplates on its underside for protecting cylinders from the bottom side; said pipes are used to connect the top and bottom plates through said apertures; and said fastening mechanism is used to join one end of each pipe to said apertures located on said top plate and the other end to said apertures located on said bottom plate.

In accordance with another aspect of the present invention, there is provided an attachable and portable holder for use in holding up to six cylinders, comprising: a top plate, a bottom plate, at least four pipes, and at least a fastening mechanism. The top plate includes at least six compartments, at least four side bracket plates for joining said compartments and at least four apertures located on the said top plate; the bottom plate features at least four compartments, at least four side bracket plates for joining said compartments, at least four apertures located on the said bottom plate, and at least four supporting baseplates on its underside for protecting cylinders from the bottom side; said pipes are used to connect the top and bottom plates through said apertures; and said fastening mechanism is used to join one end of each pipe to said apertures located on said top plate and the other end to said apertures located on said bottom plate.

Other aspects and features of the present invention will become apparent to those ordinarily skilled in the art upon review of the following description of specific embodiments of the invention in conjunction with the accompanying figures.

### DETAILED DESCRIPTION

The description represents an embodiment of the present invention an attachable or assembled and portable tank or cylinders holder. The holder system may be formed out of a solid structure from metal, plastics, composites or alloy materials but is not limited to these materials. In one embodiment, the system 1 is designed so that up to four tanks or cylinders can be placed inside the holder in compartments.

The words “tank” and “cylinder” are used interchangeably.

The words “assemble or assembled” and “attachable” are used interchangeably.

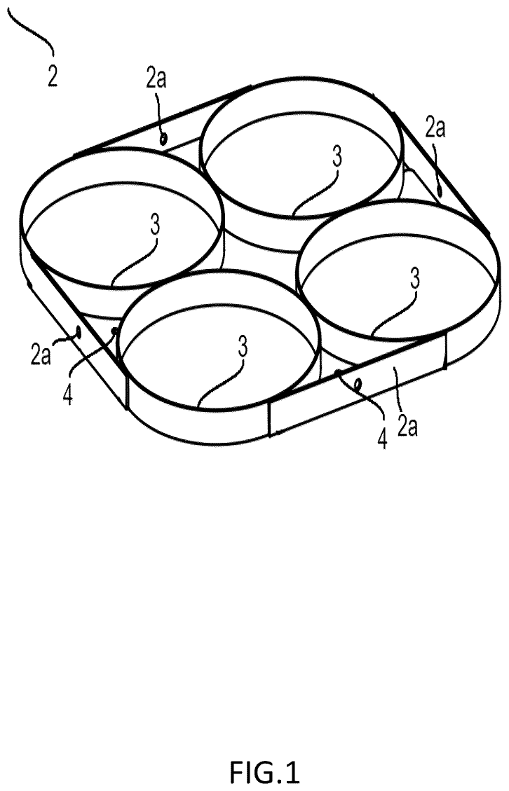

FIG. 1 shows the perspective views of the top plate (2). The top plate (2) comprises at least four compartments (3), joined together by at least four side bracket plates (2a) and featuring at least four apertures (4) located on the said top plate for fastener placement.

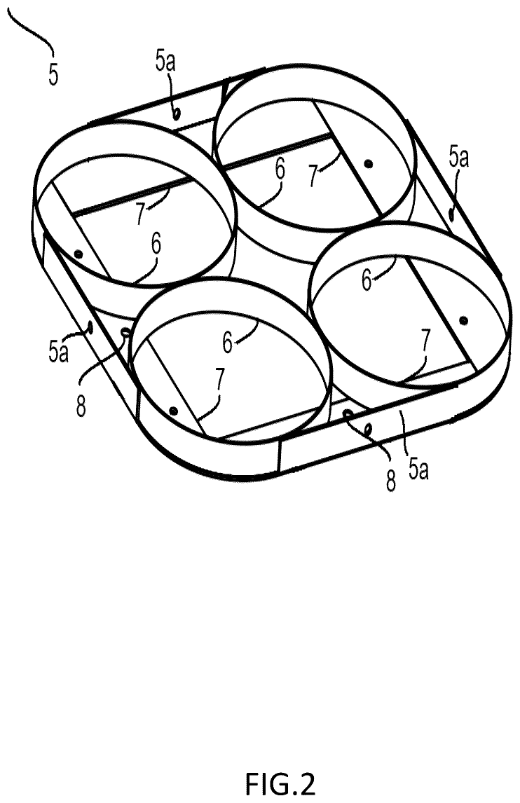

FIG. 2 shows the perspective views of the bottom plate (5). The bottom plate (5) includes at least four compartments (6) joined by at least four side bracket plates (5a), at least four supporting baseplates (7) on its underside, and at least four apertures (8) located on the said bottom plate (5) for fastener placement.

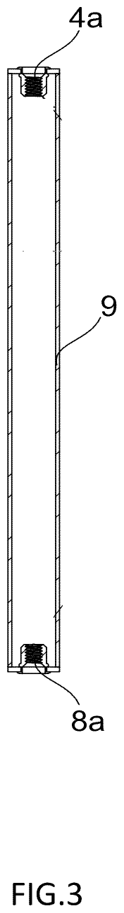

FIG. 3 depicts the front view of the pipe (9). The pipe (9) has two open ends: the first end (4a) and the second end (8a). The first end (4a) connects to the aperture (4) on the top plate (2) and is secured using fasteners applied from the top side of the plate, ensuring a firm attachment. Similarly, the second end (8a) connects to the aperture (8) on the bottom plate (5) and is securely fixed using fasteners applied from the bottom side of the plate.

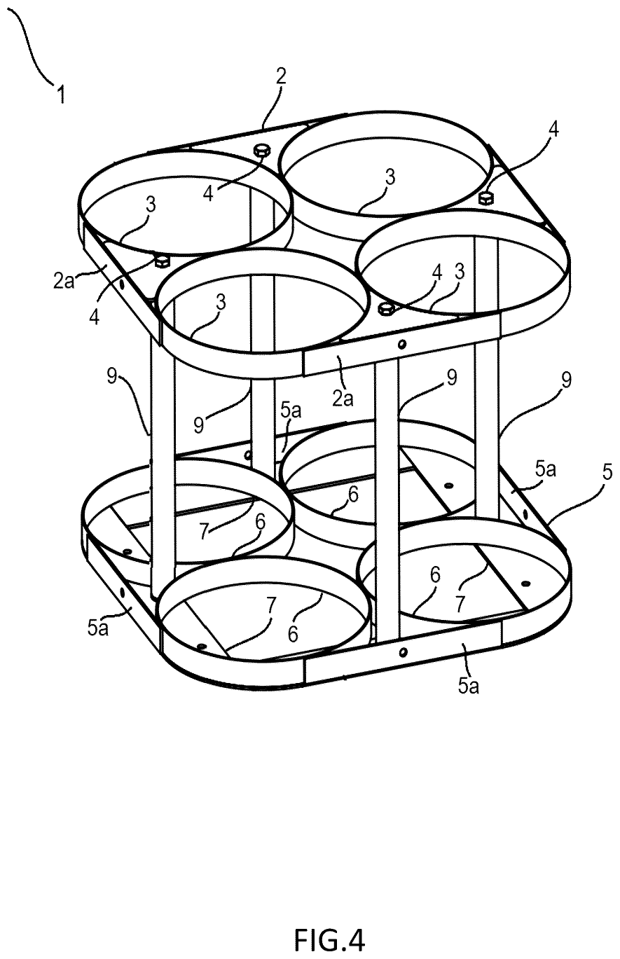

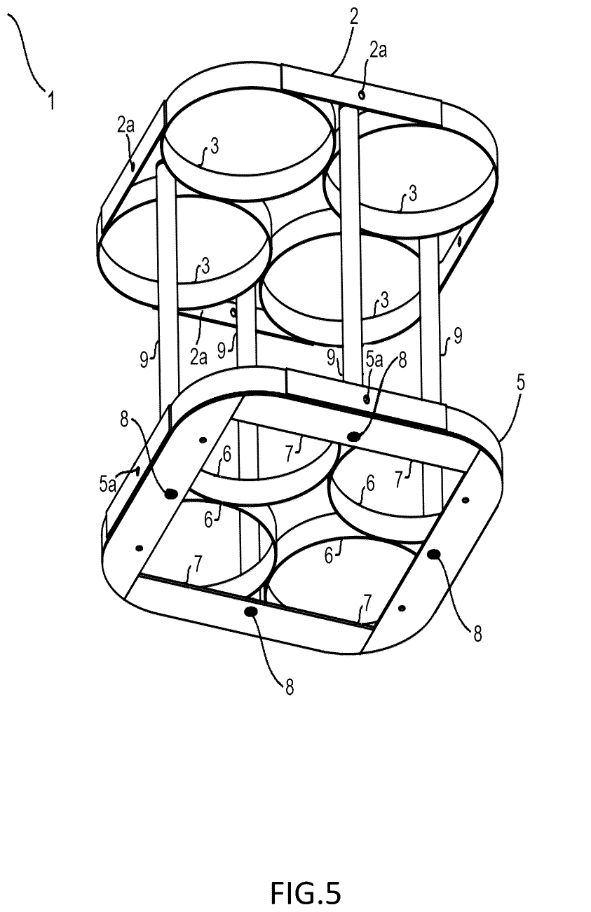

FIG. 4 and FIG. 5 are top and bottom perspective views of the cylinder holder system 1. The holder system (1) consists of a top plate (2), a bottom plate (5), at least four pipes (9), and at least one fastening mechanism. The system is structured with two plates—a top plate (2) and a bottom plate (5)—connected by at least four pipes (9), secured using fasteners.

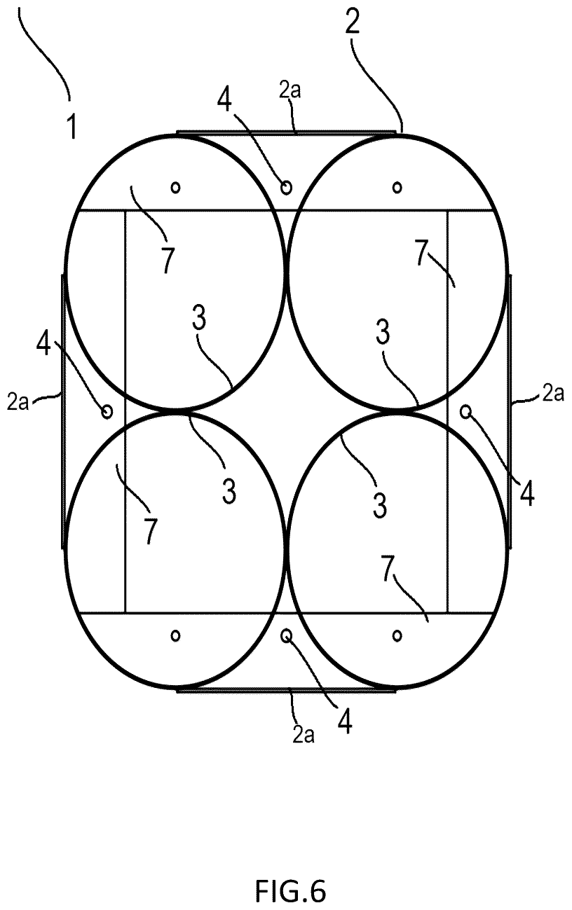

The top plate (2) includes at least four compartments (3), formed by the connection of at least four side bracket plates (2a). It also features at least four apertures (4) designed to connect or attach to one end (4a) of said pipe (9), with fasteners securing the assembly (see FIG. 6).

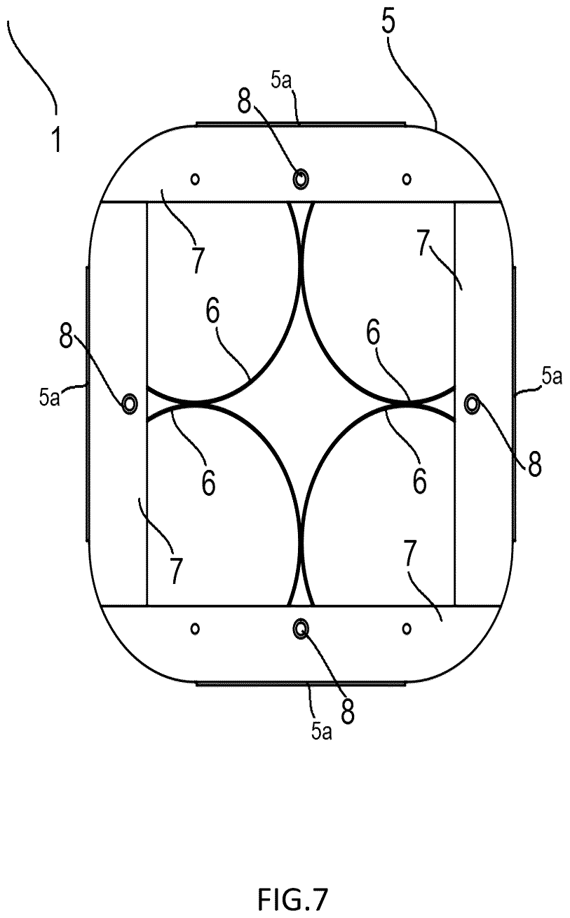

Similarly, the bottom plate (5) comprises at least four compartments (6), which are joined by at least four side bracket plates (5a). These are further supported by at least four supporting base-plates (7) located on the underside of the bottom plate (5). The bottom plate (5) also includes at least four apertures (8), which attach to the opposite ends (8a) of said pipes (9) Fasteners are used to secure all components of the system firmly together (see FIG. 7).

In one embodiment, the shapes of the top plate (2) and bottom plate (5) include, but are not limited to, square, rounded square, or squircle. In another embodiment, the shapes of the compartments—such as compartment(s) (3) of the top plate (2) and compartment(s) (6) of the bottom plate (5)—are circular or ring-shaped, though not limited to these specific forms. In another embodiment, the shape of the area where the apertures are located includes, but is not limited to, square, rounded-square, and triangular configurations.

In one embodiment, the length and width of the top plate (2) and the bottom plate (5) may range from approximately 355.6 mm (14 inches) to approximately 406.4 mm (16 inches). The height of the top plate (2) and the bottom plate (5) may range from approximately 12.5 mm to approximately 63.5 mm (2.5 inches). In another embodiment, the size of the compartments—such as compartment(s) (3) of the top plate (2) and compartment(s) (6) of the bottom plate (5)—may range from approximately Ø170 to approximately Ø190.

In one embodiment, the shape of the supporting baseplates (7) of the bottom plate (5) include but not limited to rectangle, rounded rectangle or round same side corner. In another embodiment, the length of the supporting baseplate (7) of the bottom plate (5) may range from approximately 254 mm (10 inches) to approximately 304.8 mm (12 inches). The width of the supporting baseplates 7 of the bottom plate 5 may range from approximately 38.1 mm (1.5 inches) to approximately 88.9 mm (3.5 inches). The height of the baseplate 7 of the bottom plate 5 may range from approximately 2 mm to approximately 5 mm. At least one hole or aperture (8) is present on at least one supporting base plate (7) of the bottom plate (5). From the underside of the bottom plate (5), a fastener passes through this aperture (8) to connect one end (8a) of a pipe (9) to the bottom plate (5), securing them together.

Side bracket plates—such as side bracket plates (2a) of the top plate (2) and side bracket plates (5a) of the bottom plate (5)—are crucial for maintaining the structural integrity of compartments, whether they are part of the top or bottom plate. They are designed to hold different sections or compartments together, preventing separation or instability. By attaching to the sides, these plates help keep the entire assembly secure and aligned, ensuring the compartments function cohesively. The length of the side bracket plates may range from approximately 152.4 mm (6 inches) to approximately 203.2 mm (8 inches). The height of the side bracket plates may range from approximately 12.5 mm to approximately 63.5 mm (2.5 inches). In one embodiment, the shape of the side bracket plate and/or handle-like bracket plate includes but not limited to rectangle, rounded rectangle, flat, isosceles trapezoid.

At least four pipes 9 securely connect the bottom and top plates with the help of at least one fastening mechanism, forming a sturdy structure to hold the cylinders. The length of the pipe 9 may range from approximately 241.3 mm (9.5 inches) to approximately 381 mm (15 inches). The size of each side of the pipe 9 may range from approximately Ø18 to approximately Ø22.

At least one fastening mechanism includes fasteners but not limited to hex head screw, flat head screw, pan head screw, and/or nut, is employed to secure the holder system in place.

In accordance with one aspect of the present invention, there is provided an attachable and portable holder for use in holding up to four cylinders, comprising: a top plate, a bottom plate, at least four pipes, and at least a fastening mechanism.

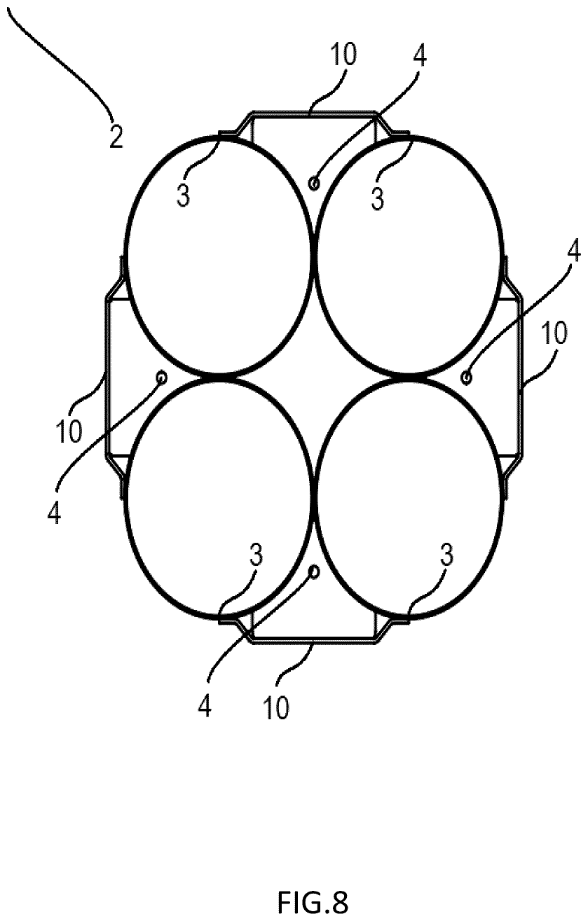

In FIG. 8 shows the top views of another embodiment of the top plate (2). The top plate (2) includes at least four compartments 3, at least four side handle or handle-like plates (10) for joining said compartments (2) and at least four apertures (4) located on the said top plate (2).

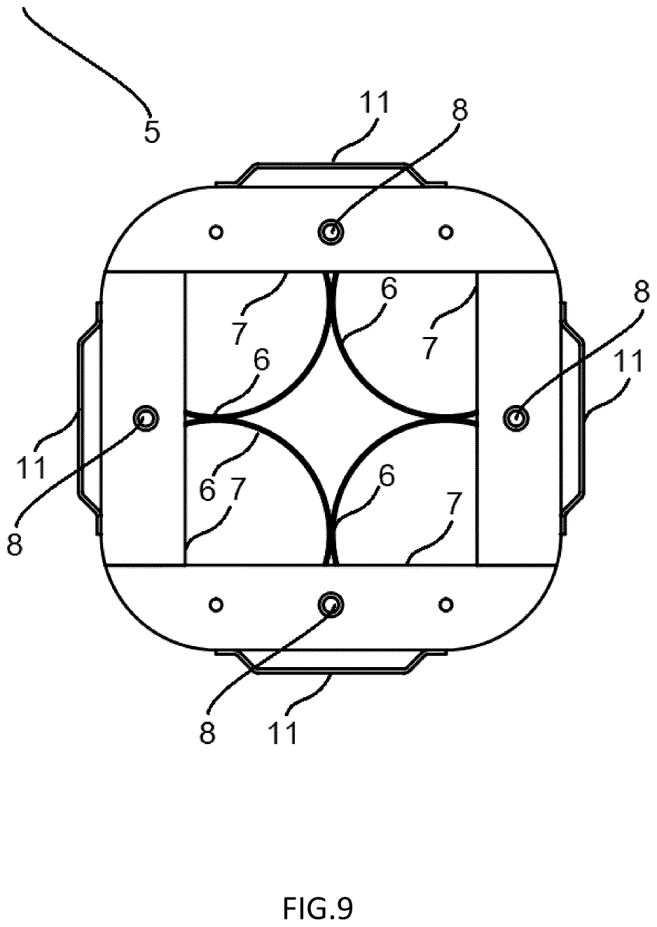

FIG. 9 shows the perspective views of another embodiment of the bottom plate (5). The bottom plate (5) features at least four compartments (6), at least four side handle or handle-like plates (11) for joining said compartments (6), at least four apertures (8) located on the said bottom plate, and at least four supporting baseplates (7) on its underside for protecting cylinders from the bottom side.

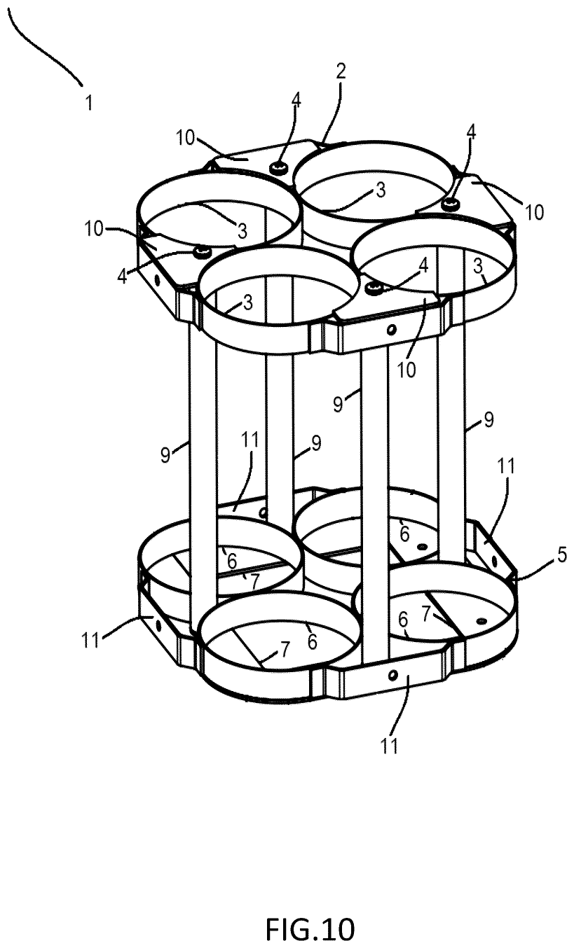

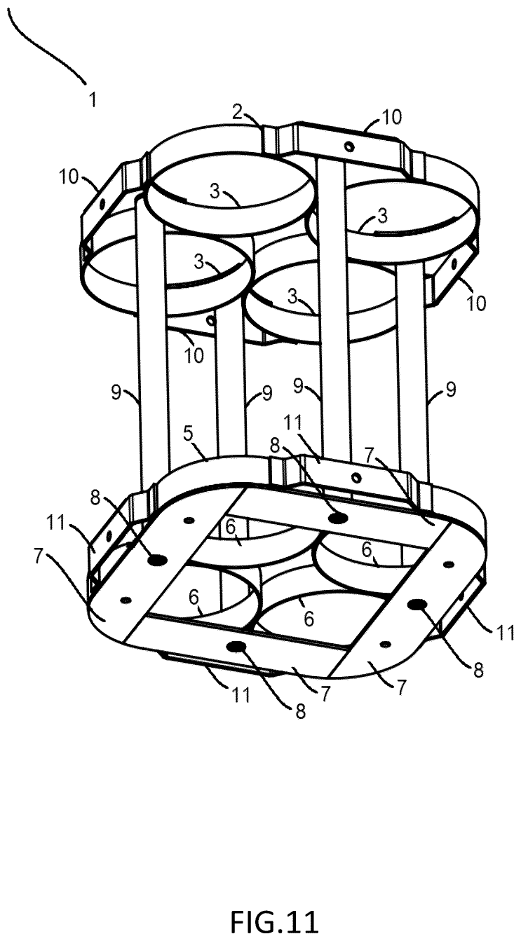

FIG. 10 and FIG. 11 are top and bottom perspective views of another embodiment of the cylinder holder system (1). The holder system (1) consists of a top plate (2), a bottom plate (5), at least four pipes (9), and at least one fastening mechanism. The system is structured with two plates—a top plate (2) and a bottom plate (5)—connected by at least four pipes (9), secured using fasteners.

The top plate (2) includes at least four compartments (3), formed by the connection of at least four side handle or handle-like plates (10). It also features at least four apertures (4) designed to connect or attach to one end (4a) of said pipe (9), with fasteners securing the assembly.

Similarly, the bottom plate (5) comprises at least four compartments (6), which are joined by at least four side handle or handle-like plates (11). These are further supported by at least four supporting base-plates (7) located on the underside of the bottom plate (5). The bottom plate (5) also includes at least four apertures (8), which attach to the opposite ends (8a) of said pipes (9) Fasteners are used to secure all components of the system firmly together.

In one embodiment, the shapes of the top plate (2) and bottom plate (5) include, but are not limited to, square, rounded square, or squircle. In another embodiment, the shapes of the compartments—such as compartment(s) (3) of the top plate (2) and compartment(s) (6) of the bottom plate (5)—are circular or ring-shaped, though not limited to these specific forms. In another embodiment, the shape of the area where the apertures are located includes, but is not limited to, square, rounded-square, and triangular configurations.

In one embodiment, the length and width of the top plate (2) and the bottom plate (5) may range from approximately 355.6 mm (14 inches) to approximately 406.4 mm (16 inches). The height of the top plate (2) and the bottom plate (5) may range from approximately 12.5 mm to approximately 63.5 mm (2.5 inches). In another embodiment, the size of the compartments—such as compartment(s) (3) of the top plate (2) and compartment(s) (6) of the bottom plate (5)—may range from approximately Ø170 to approximately Ø190.

In one embodiment, the shape of the supporting baseplates (7) of the bottom plate (5) include but not limited to rectangle, rounded rectangle or round same side corner. In another embodiment, the length of the supporting baseplate (7) of the bottom plate (5) may range from approximately 254 mm (10 inches) to approximately 304.8 mm (12 inches). The width of the supporting baseplates (7) of the bottom plate (5) may range from approximately 38.1 mm (1.5 inches) to approximately 88.9 mm (3.5 inches). The height of the baseplate (7) of the bottom plate (5) may range from approximately 2 mm to approximately 5 mm. At least one hole or aperture (8) is present on at least one supporting base plate (7) of the bottom plate (5). From the underside of the bottom plate (5), a fastener passes through this aperture (8) to connect one end (8a) of a pipe (9) to the bottom plate (5), securing them together.

Side handle or handle-like plates—such as side handle or handle-like plates (10) of the top plate (2) and side handle or handle-like plates (11) of the bottom plate (5)—are crucial for maintaining the structural integrity of compartments, whether they are part of the top or bottom plate. They are designed to hold different sections or compartments together, preventing separation or instability. By attaching to the sides, these plates help keep the entire assembly secure and aligned, ensuring the compartments function cohesively. The length of the side handle or handle-like plates may range from approximately 152.4 mm (6 inches) to approximately 203.2 mm (8 inches). The height of the side handle or handle-like plates may range from approximately 12.5 mm to approximately 63.5 mm (2.5 inches). In one embodiment, the shape of the side handle-like bracket plate includes but not limited to isosceles trapezoid.

At least four pipes 9 securely connect the bottom and top plates with the help of at least one fastening mechanism, forming a sturdy structure to hold the cylinders. The length of the pipe 9 may range from approximately 241.3 mm (9.5 inches) to approximately 381 mm (15 inches). The size of each side of the pipe 9 may range from approximately Ø18 to approximately Ø22.

At least one fastening mechanism includes fasteners but not limited to hex head screw, flat head screw, pan head screw, and/or nut, is employed to secure the holder system in place.

In accordance with one aspect of the present invention, there is provided an attachable and portable holder for use in holding up to six cylinders, comprising: a top plate, a bottom plate, at least four pipes, and at least a fastening mechanism.

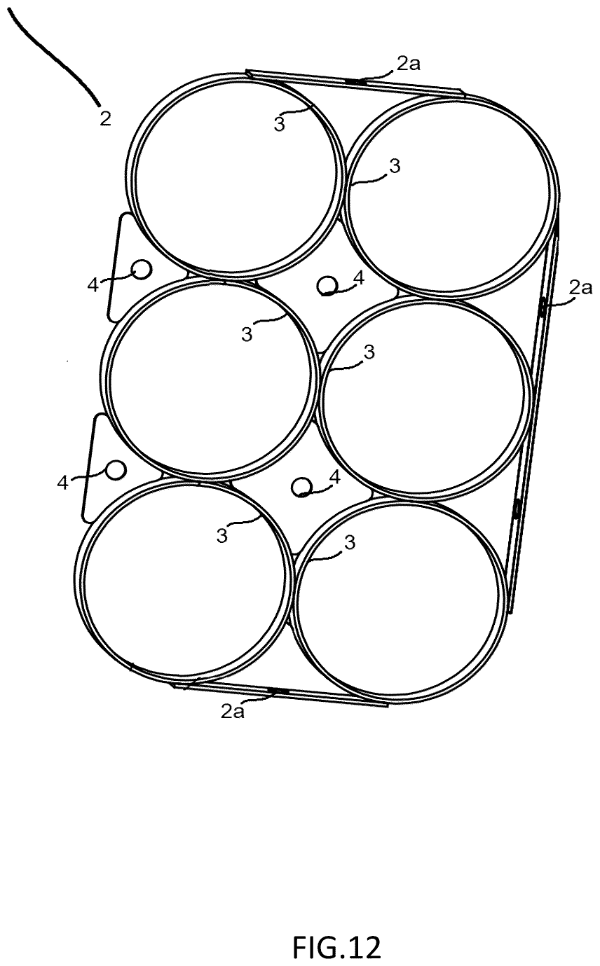

FIG. 12 shows the perspective views of another embodiment of the top plate (2). The top plate (2) comprises at least six compartments (3), joined together by at least three side bracket plates (2a) and featuring at least four apertures (4) located on the said top plate (2) for fastener placement.

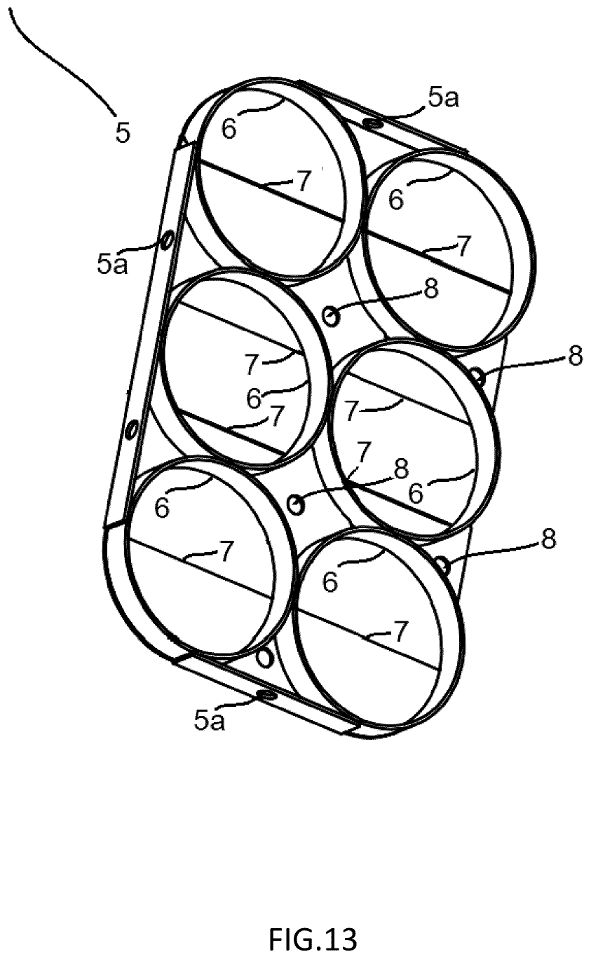

FIG. 13 shows the perspective views of another embodiment of the bottom plate (5). The bottom plate (5) includes at least six compartments (6) joined by at least three side bracket plates (5a), at least four supporting baseplates (7) on its underside, and at least four apertures (8) located on the said bottom plate (5) for fastener placement.

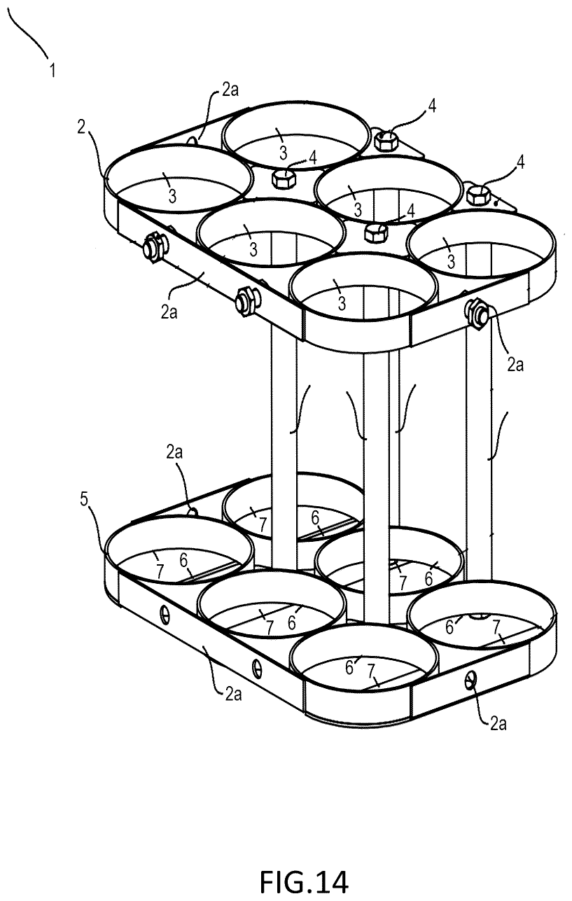

FIG. 14 is a perspective view of another embodiment of the cylinder holder system 1. The holder system (1) consists of a top plate (2), a bottom plate (5), at least four pipes (9), and at least one fastening mechanism. The system is structured with two plates—a top plate (2) and a bottom plate (5)—connected by at least four pipes (9), secured using fasteners.

The top plate (2) includes at least six compartments (3), formed by the connection of at least three side bracket plates (2a). It also features at least four apertures (4) designed to connect or attach to one end (4a) of said pipe (9), with fasteners securing the assembly.

Similarly, the bottom plate (5) comprises at least six compartments (6), which are joined by at least three side bracket plates (5a). These are further supported by at least four supporting base-plates (7) located on the underside of the bottom plate (5). The bottom plate (5) also includes at least four apertures (8), which attach to the opposite ends (8a) of said pipes (9) Fasteners are used to secure all components of the system firmly together.

In one embodiment, the shapes of the top plate (2) and bottom plate (5) include, but are not limited to, square, rounded square, or squircle. In another embodiment, the shapes of the compartments—such as compartment(s) (3) of the top plate (2) and compartment(s) (6) of the bottom plate (5)—are circular or ring-shaped, though not limited to these specific forms. In another embodiment, the shape of the area where the apertures are located includes, but is not limited to, square, rounded-square, and triangular configurations.

In one embodiment, the length of the top plate (2) and the bottom plate (5) may range from approximately 330.2 mm (13 inches) to approximately 431.8 mm (17 inches). The width of the top plate (2) and the bottom plate (5) may range from approximately 215.9 mm (8.5 inches) to approximately 419.1 mm (16.5 inches). The height of the top plate (2) and the bottom plate (5) may range from approximately 12.5 mm to approximately 63.5 mm (2.5 inches). In another embodiment, the size of the compartments—such as compartment(s) (3) of the top plate (2) and compartment(s) (6) of the bottom plate (5)—may range from approximately Ø170 to approximately Ø190.

In one embodiment, the shape of the supporting baseplates (7) of the bottom plate (5) include but not limited to rectangle, rounded rectangle or round same side corner. In another embodiment, the length of the supporting baseplate (7) of the bottom plate (5) may range from approximately 228.6 mm (9 inches) to approximately 304.8 mm (12 inches). The width of the supporting baseplates 7 of the bottom plate (5) may range from approximately 38.1 mm (1.5 inches) to approximately 88.9 mm (3.5 inches). The height of the baseplate 7 of the bottom plate 5 may range from approximately 2 mm to approximately 5 mm. At least one hole or aperture (8) is present on at least one supporting base plate (7) of the bottom plate (5). From the underside of the bottom plate (5), a fastener passes through this aperture (8) to connect one end (8a) of a pipe (9) to the bottom plate (5), securing them together.

Side bracket plates—such as side bracket plates (2a) of the top plate (2) and side bracket plates (5a) of the bottom plate (5)—are crucial for maintaining the structural integrity of compartments, whether they are part of the top or bottom plate. They are designed to hold different sections or compartments together, preventing separation or instability. By attaching to the sides, these plates help keep the entire assembly secure and aligned, ensuring the compartments function cohesively. The length of the side bracket plates may range from approximately 152.4 mm (6 inches) to approximately 203.2 mm (8 inches). The height of the side bracket plates may range from approximately 12.5 mm to approximately 63.5 mm (2.5 inches). In one embodiment, the shape of the side bracket plate and/or handle-like bracket plate includes but not limited to rectangle, rounded rectangle, flat, isosceles trapezoid.

At least four pipes 9 securely connect the bottom and top plates with the help of at least one fastening mechanism, forming a sturdy structure to hold the cylinders. The length of the pipe 9 may range from approximately 241.3 mm (9.5 inches) to approximately 381 mm (15 inches). The size of each side of the pipe 9 may range from approximately Ø18 to approximately Ø22.

At least one fastening mechanism includes fasteners but not limited to hex head screw, flat head screw, pan head screw, and/or nut, is employed to secure the holder system in place.

In one embodiment of the present invention an attachable and portable cylinders holder, said top plate and said bottom forms at least eight compartments and at least four pipes are to be attached between the bottom plate and the top plate. In another embodiment, said top plate and said bottom forms at least eight compartments and at least six pipes are to be attached between the bottom plate and the top plate. In another embodiment, said top plate and said bottom forms at least eight compartments and at least six pipes are to be attached between the bottom plate and the top plate. In another embodiment, said top plate and said bottom forms at least ten compartments and at least eight pipes are to be attached between the bottom plate and the top plate.

It will be apparent to one skilled in the art that numerous modifications and departures from the specific embodiments described herein may be made without departing from the spirit and scope of the present invention.

What is claimed is:

1. A holder system for use in holding one or more oxygen tanks, said holder comprising:
a top plate means forming at least four compartments, at least four side bracket plates, and at least four apertures;
a bottom plate means forming at least four compartments, at least four side bracket plates, and at least four apertures; at least four supporting baseplates on its underside;
at least four pipes are used to connect the top and bottom plates through said apertures;
and at least a fastening mechanism is used to join one end of each pipe to said apertures located on said top plate and the other end to said apertures located on said bottom plate.

2. The holder of claim 1, wherein said top plate, bottom plate and pipes means are formed from material but not limited to carbon steel.

3. The holder of claim 1, wherein said at least a fastening mechanism includes fasteners but not limited to hex head screw, flat head screw, pan head screw and/or nut.

4. The holder of claim 1, wherein said compartments includes but not limited to are circular or ring-shaped; the shape of location of said apertures includes but not limited to square, rounded-square, or triangle; and the shape of said side bracket plates and said supporting baseplates includes but not limited to rectangle, rounded rectangle, flat.

5. The holder of claim 1, wherein said the system is attachable or portable.

6. A holder system for use in holding one or more oxygen tanks, said holder comprising:
top plate means forming at least four compartments, at least four side handle-like plates, and at least four apertures;
bottom plate means forming at least four compartments, at least four side handle-like plates, and at least four apertures; at least four supporting baseplates on its underside;
at least four pipes are used to connect said top and bottom plates through said apertures;
and at least a fastening mechanism is used to join one end of each pipe to said apertures located on said top plate and the other end to said apertures located on said bottom plate.

7. The holder of claim 6, wherein said top plate, bottom plate and pipes means are formed from material but not limited to carbon steel.

8. The holder of claim 6, wherein said at least a fastening mechanism includes fasteners but not limited to hex head screw, flat head screw, pan head screw and/or nut.

9. The holder of claim 6, wherein said compartments includes but not limited to are circular or ring-shaped; the shape of location of said apertures includes but not limited to square, rounded-square, or triangle; the shape of said side handle-like plates includes but not limited to isosceles trapezoid; and said supporting baseplates includes but not limited to rectangle, rounded rectangle, or flat.

10. The holder of claim 6, wherein said the system is portable.

11. A holder system for use in holding one or more oxygen tanks, said holder comprising:
top plate means forming at least six compartments, at least four side bracket plates, and at least four apertures;
bottom plate means forming at least six compartments, at least four side bracket plates, and at least four apertures; at least four supporting baseplates on its underside;
at least four pipes are used to connect said top and bottom plates through said apertures;
and at least a fastening mechanism is used to join one end of each pipe to said apertures located on said top plate and the other end to said apertures located on said bottom plate.

12. The holder of claim 11, wherein said top plate, bottom plate and pipes means are formed from material but not limited to carbon steel.

13. The holder of claim 11, wherein said at least a fastening mechanism includes fasteners but not limited to hex head screw, flat head screw, pan head screw and/or nut.

14. The holder of claim 11, wherein said compartments includes but not limited to are circular or ring-shaped; the shape of location of said apertures includes but not limited to square, rounded-square, or triangle; the shape of said side bracket plates includes but not limited to handle-like plates, isosceles trapezoid rectangle, rounded rectangle, or flat; and said supporting baseplates includes but not limited to rectangle, rounded rectangle, or flat.

15. The holder of claim 11, wherein said the system is attachable or portable.

16. The holder of claim 11, wherein said top and bottom plates forms at least eight compartments and at least four pipes are to be attached between the bottom plate and the top plate.

17. The holder of claim 11, wherein said top and bottom plate forms at least eight compartments and at least six pipes are to be attached between the bottom plate and the top plate.

18. The holder of claim 11, wherein said top and bottom plates forms at least ten compartments and at least eight pipes are to be attached between the bottom plate and the top plate.
